(19) United States
(12) Patent Application Publication
(10) Pub. No.: US 2004/0026342 A1
(43) Pub. Date: Feb. 12, 2004

(54) Sand stabilization method and apparatus

(76) Inventors: Scott O'Brien, Hendersonville, TN (US); Denny Sprecher, South Jordan, UT (US)

Correspondence Address: William H. Logsdon, WEBB ZIESENHEIM LOGSDON ORKIN & HANSON, P.C., 700 Koppers Building, 436 Seventh Avenue, Pittsburgh, PA, 15219-1818, US

(21) Appl. No.: 10/389,692

(22) Filed: Mar. 14, 2003

Related U.S. Application Data
(60) Provisional application No. 60/364,921, filed on Mar. 15, 2002.

(51) Int. Cl. B01D 21/26

(52) U.S. Cl. 210/788; 210/512.1

(57) ABSTRACT

A sand stabilization apparatus that preferably includes a first pump, a first separator fluidly connected to the first pump, a first attrition device fluidly connected to the first separator, a second pump fluidly connected to the first attrition device, a second separator fluidly connected to the second pump, and a dewatering device fluidly connected to the second separator.

### CROSS-REFERENCE TO RELATED APPLICATIONS

This application claims the benefit of U.S. Provisional Patent Application Serial No. 60/364,921, filed Mar. 15, 2002, entitled “Sand Stabilization Method and Apparatus”, herein incorporated by reference in its entirety.

### BACKGROUND OF THE INVENTION

1. Field of the Invention

The present invention generally relates to particle separation and, more particularly, to sand and water separators.

2. Brief Description of the Prior Art

Fine aggregates must meet certain criteria which describes their cleanliness and durability in order for them to be acceptable for use in various industries, particularly concrete. Cleanliness and durability are measured by ASTM test procedures which assign a sand equivalency number and a durability index. Presently, many producers of fine aggregates find that their raw materials contain particles comprised of a hard clay which behaves much like a discrete sand particle. Samples of processed aggregates often pass the sand equivalency and durability tests when the sampling occurs immediately after processing of the sand. However, when left to age for several days in a stockpile, the once competent clay particle becomes soft and fragile. The breakdown of these clay particles causes the quality of the sand to degenerate as demonstrated by lower sand equivalency numbers and reduced durability indexes.

A number of solutions to this problem are presently employed. The most common are inclusion of a blade mill and/or double stage of screw washing after the sand has been classified the lowering of the standards acceptable by regulating agencies, and abandoning the deposit.

The first two solutions have been found to give some relief to the problem. However, testing of products that have undergone these processing techniques show that considerable deleterious materials remain. It is believed that neither of these systems provide a sufficiently high-energy environment to shear the clays, or long enough residence time to allow the energy to be used effectively.

Another problem facing some producers is the passing of regulations for aggregates to contain a minimum amount of recycled materials generated by the razing of infrastructure, such as roads and buildings. The debris from these sources can be a viable source for competent aggregate but it often must be treated to remove many types of deleterious materials that are present. One such bothersome material is wallboard or plaster. Solutions to this problem are similar to those listed above.

### SUMMARY OF THE INVENTION

An object of the sand stabilization apparatus and method according to the present invention is to increase the quality of an aggregate or recycled aggregate that includes particles of materials which tend to degrade over time and hence reduce the viability of that aggregate as an ingredient in concrete.

The sand stabilization apparatus and method according to the present invention uses mineral processing technologies to effectively deal with these deleterious materials. By creating an environment of high shear coupled with state-of-the-art dewatering/desliming technologies, the sand stabilization apparatus and method improves product quality over current screw washer/blade mill designs. The present invention may be incorporated in the initial design of a plant or simply set up next to an existing operation and can be supplied in several configurations to match the application.

A sand stabilization apparatus configuration according to one embodiment of the present invention may include a first pump, a first separator fluidly connected to the first pump, a first attrition device fluidly connected to the first separator, a second pump fluidly connected to the first attrition device, a second separator fluidly connected to the second pump, and a dewatering device fluidly connected to the second separator.

The first pump is preferably a high agitation sump pump. The first separator and the second separator are selected from the group that includes a hydrocyclone, a distributor fluidly connected to two or more hydrocyclones, and an elutriation column. The second separator may also be selected from the group that includes rising current classifier, a dense media separator, and a hindered settling classifier. The dewatering device is preferably a VELCO brand screen, commercially available from LPT.

A preferred method to filter sand from a sand slurry may include the steps of providing a slurry feed containing water, sand, and undesirable particulates, removing excess water from the slurry feed, scrubbing the slurry feed to remove substantially all of the undesirable particulates to produce a scrubbed slurry feed, adding additional water to the scrubbed slurry feed, and removing substantially all water from the scrubbed slurry feed to obtain substantially dry sand. An additional step may include diluting the slurry feed via a dewatering circuit after the step of providing a slurry feed containing undesirable particulates.

A first pump fluidly connected to the slurry feed may also be provided, along with the step of adding additional water to the slurry feed via the first pump. The step of removing excess water from the slurry feed may include the step of flowing the slurry feed through a first separator. The step of scrubbing the slurry feed to remove substantially all of the undesirable particulates and to produce a scrubbed slurry feed may include the step of flowing the slurry feed through a first attrition device after the step of flowing the slurry feed through a first separator. A step of providing water to the slurry feed in the first attrition device may also be used.

A second pump fluidly connected to the first attrition device may also be provided, wherein the step of adding additional water to the scrubbed slurry feed includes the step of adding water through the second pump. A step of routing water removed during the step of removing substantially all water from the scrubbed slurry feed to obtain substantially dry sand along with any residual sand contained therein to the second pump may also be used. The step of removing substantially all water from the scrubbed slurry feed to obtain substantially dry sand may include the step of flowing the scrubbed slurry feed through a second separator.

The step of removing substantially all water from the scrubbed slurry feed to obtain substantially dry sand may include the step of flowing the scrubbed slurry feed through a dewatering screen.

These and other advantages of the present invention will be clarified in the description of the preferred embodiment taken together with the attached drawings in which like reference numerals represent like elements throughout.

### BRIEF DESCRIPTION OF THE DRAWING

FIG. 1 is a schematic view of a sand stabilization apparatus and method according to the present invention.

### DETAILED DESCRIPTION OF PRESENT INVENTION

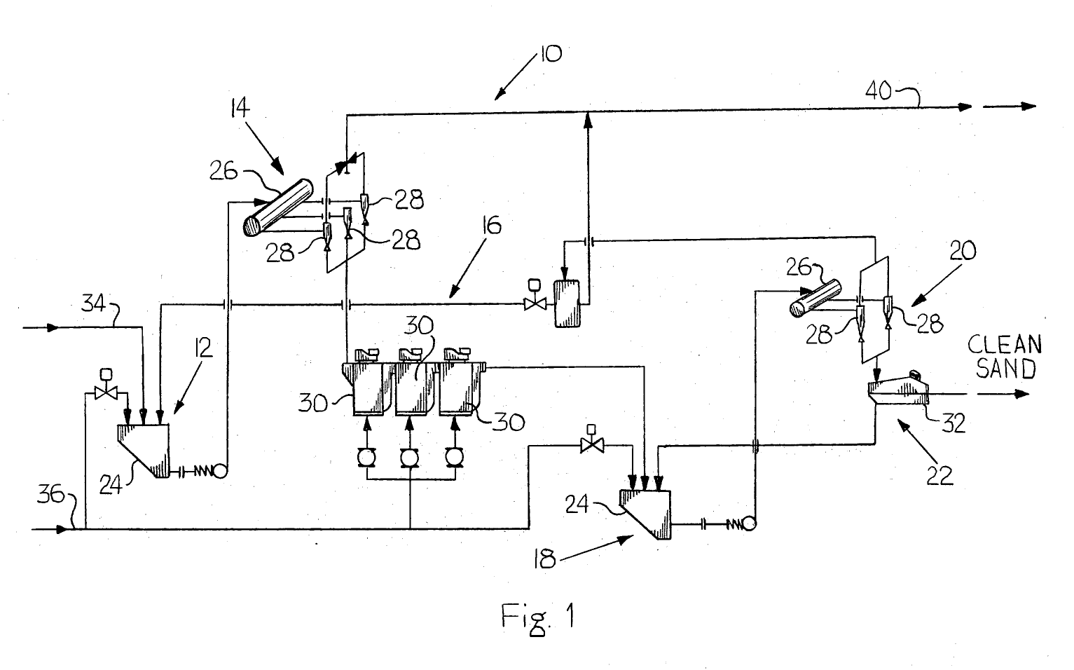

In general, as shown in FIG. 1, the sand stabilization apparatus and method 10 according to the present invention may generally include a first pump 12, a first separator 14, a first attrition device 16, a second pump 18, a second separator 20, and a dewatering device 22.

The first pump 12 and the second pump 18 may each generally include a high agitation sump pump 24, such as an FCS-3000 Series sump pump commercially available from Linatex Process Technologies, Gallatin, Tenn., or any other suitable device.

The first separator 14 and the second separator 20 preferably each include a distributor 26 fluidly connected to one or more hydrocyclones fitted with underflow regulators 28. If only one hydrocyclone 28 is used, the distributor 26 is not required. One type of hydrocyclone fitted with an underflow regulator 28 is a model S-518AX LPT commercially available from Linatex Process Technologies. However, any other suitable device may also be used. Sand slurry may be processed through the first and second separators 14, 20 to ensure a consistently dense feed slurry and remove any free or subsequently liberated clays. Other separators 14, 20 may be added within the sand stabilization apparatus 10 to allow for interstage washing of the sand. The second separator 20 may also be used as the final washing apparatus after all attritioning has occurred.

An alternative first separator 14 or second separator 20 is an elutriation column, such as a flat bottom classifier commercially available from Linatex Process Technologies. The elutriation column is beneficial because of the potential for lower water usage.

The first attrition device 16 abrades particulates in the slurry. Acceptable first attrition devices 16 include Model 17 LIBERATORS brand scrubbers 30, commercially available from Linatex Process Technologies, or any other suitable device. The first attrition device 16 reduces contaminants in the final product, to improve color, and also improve subsequent separation behavior. In the clay industry, the attrition process is referred to as “blunging” and is the primary process used to liberate and disperse the sand and clays found in a mined matrix. In the event that the first attrition device 16 produces so many fine particles that the slurry becomes self-lubricating, the sand stabilizer apparatus 10 according to the present invention is designed to be modified for additional inter-stage washes through the addition of additional separators 14, 20.

Finally, the dewatering device 22 is used to ensure that as much process water as possible is removed from the sand prior to stockpile. Since the fine clay particles generally follow the water, lower product moistures translate directly to less clay in the product. A VELCO brand screen 32 commercially available from Linatex Process Technologies is an acceptable dewatering device 22, but any other suitable dewatering device 22 may also be used. Any of the devices discussed above may be lined with rubber or other suitable material which resists sand abrasion.

With continuing reference to FIG. 1, and by way of example only, the following variables are based on treating 150 stph of sand for approximately three minutes. In this example only, it is assumed that a slurry feed 34 is provided from a discharge stream from a classifying tank that contains approximately 35% solids by weight or a water flow rate of approximately 1115 GPM.

The slurry feed 34 is fed at a rate of 150 stph and is directed by a customer supplied feed chute to the first pump 12. Operated in a counter current mode to conserve water, the slurry feed 34 is further diluted from a downstream dewatering circuit 36 at a rate, in this example, of approximately 1465 GPM. Sufficient additional dilution water is added to the first pump 12 to reduce the solids concentration of the slurry feed 34 to approximately 20% by weight.

The contents from the first pump 12 may be pumped to the distributor 26 which, in turn, may divide the contents to a plurality of hydrocyclone fitted with an underflow regulator 28 operating in parallel. The first separator 14 serves the dual function to remove slimes from the sand and dewater the sand for processing through the first attrition 16. The first attrition device 16 is sized on the basis of retention time required to affect the desired results. In this example, the first attrition device 16 is built in two sizes, such as a 1.7 m³ cell and a 3.4 m³ cell. Assuming a processing rate of 150 stph and 75% solids discharge from the first separator 14, inclusion of three Model 17 LIBERATOR brand scrubbers 30 will result in a scrubbing retention time of approximately three minutes.

The first attrition device 16 may be powered either electrically or through hydraulic drives. Power monitoring apparatus may provide a control system with information to maintain slurry densities within the first attrition device 16 and thus lead to a consistent performance. Moreover, water may be provided to the first attrition device 16 via the dewatering circuit 36 flow.

Upon exiting the first attrition device 16, a scrubbed sand is directed by a chute to the second pump 18. Also entering the second pump 18 is approximately 2210 GPM of clean process water in this example, preferably from customer ponds or the dewatering circuit 36. This mixture of scrubbed sand slurry and process water may be subsequently channeled to the second separator 20 for slimes removal and preliminary dewatering. More particularly, the mixture enters the distributor 26 and is divided to a plurality of hydrocyclone fitted with an underflow regulator 28 operating in parallel. The partially dewatered slurry then flows to the dewatering device 22, such as the VELCO dewatering screen. A sand discharge from the dewatering device 22 is suitable for conveying to a customer's radial stacker.

Undersize particulates from the dewatering device 22 are returned to the second pump 18 either by gravity (if site conditions permit) or by another pump. The return of undersized particulate material to the second pump 18 prevents valuable finer sand from being lost to the settling ponds. Overflow from the second separator 20 is collected in a slurry box 38 defining two outlets. One outlet of the slurry box 38 returns dilution water to the first pump 12, while the other outlet directs excess water to a slimes pond 40, slimes containment, thickener, or other suitable place.

There may be instances where further conservation of water is possible. These would most often be in situations where slimes generation is light to moderate, such as would be the case if the sand stabilization apparatus 10 according to the present invention were modified to include one or more additional inter-stage attrition devices. In these instances, the second separator 20 could be replaced with a rising current classifier, also referred to as an elutriator, dense media separator, hindered settling classifier, such as an FBC classifier commercially available from Linatex Process Technologies or any other suitable device. In the case of treating 150 stph, the FBC classifier would be sized at a twelve inch diameter and would require between approximately 500 and 1400 GPM of process water. It is believed that the use of the rising current classifier will be essential when treating demolition debris.

As noted above, the present invention is designed to increase the quality of an aggregate or recycled aggregate that includes particles of materials which tend to degrade over time and hence reduce the viability of that aggregate as an ingredient in concrete. The present invention uses mineral processing technologies to effectively deal with these deleterious materials. By creating an environment of high shear coupled with state-of-the-art dewatering/desliming technologies, the sand stabilization apparatus and method improves product quality over current screw washer/blade mill designs. The present invention may also be incorporated in the initial design of a plant or simply be set up next to an existing operation and can be supplied in several configurations to match the application.

The invention has been described with reference to the preferred embodiment. Obvious modifications and alterations will occur to others upon reading and understanding the preceding detailed description. It is intended that the invention be construed as including all such modifications and alterations insofar as they come within the scope of the appended claims or the equivalents thereof.

We claim:

1. A sand stabilization apparatus comprising:
a first pump;
a first separator fluidly connected to the first pump;
a first attrition device fluidly connected to the first separator;
a second pump fluidly connected to the first attrition device;
a second separator fluidly connected to the second pump; and
a dewatering device fluidly connected to the second separator.

2. The sand stabilization apparatus as claimed in claim 1 wherein the first pump is a high agitation sump pump.

3. The sand stabilization apparatus as claimed in claim 1 wherein the first separator and the second separator are selected from the group comprising a hydrocyclone hydrocyclones fitted with an underflow regulator, a distributor fluidly connected to two or more hydrocyclones each fitted with underflow regulators, and an elutriation column.

4. The sand stabilization apparatus as claimed in claim 1 wherein the second separator is selected from the group comprising rising current classifier, a dense media separator, and a hindered settling classifier.

5. The sand stabilization apparatus as claimed in claim 1 wherein the dewatering device separates water from solids.

6. A method to filter sand from a sand slurry comprising the steps of:
a) providing a slurry feed containing water, sand, and undesirable particulates;
b) removing excess water from the slurry feed;
c) scrubbing the slurry feed to remove substantially all of the undesirable particulates to produce a scrubbed slurry feed;
d) adding additional water to the scrubbed slurry feed; and
e) removing substantially all water from the scrubbed slurry feed to obtain substantially dry sand.

7. The method as claimed in claim 6 further comprising the step of diluting the slurry feed via a dewatering circuit after the step of providing a slurry feed containing water, sand, and undesirable particulates.

8. The method as claimed in claim 6 further comprising a first pump fluidly connected to the slurry feed and further comprising the step of adding additional water to the slurry feed via the first pump.

9. The method as claimed in claim 6 wherein the step of removing excess water from the slurry feed further comprises the step of flowing the slurry feed through a first separator.

10. The method as claimed in claim 9 wherein the step of scrubbing the slurry feed to remove substantially all of the undesirable particulates and to produce a scrubbed slurry feed further comprises the step of flowing the slurry feed through a first attrition device after the step of flowing the slurry feed through a first separator.

11. The method as claimed in claim 10 further comprising the step of providing water to the slurry feed in the first attrition device.

12. The method as claimed in claim 10 further comprising a second pump fluidly connected to the first attrition device, wherein the step of adding additional water to the scrubbed slurry feed further comprises the step of adding water through the second pump.

13. The method as claimed in claim 12 further comprising the step of routing water removed in step (e) and any residual sand contained therein to the second pump.

14. The method as claimed in claim 6 wherein the step of removing substantially all water from the scrubbed slurry feed to obtain substantially dry sand further comprises the step of flowing the scrubbed slurry feed through a second separator.

15. The method as claimed in claim 6 wherein the step of removing substantially all water from the scrubbed slurry feed to obtain substantially dry sand further comprises the step of flowing the scrubbed slurry feed through a dewatering screen.

16. The method as claimed in claim 6 further comprising the step of routing the water removed in step (e) and any residual sand contained therein to a slurry box.
